(19) United States
(12) Patent Application Publication
(10) Pub. No.: US 2004/0158561 A1
(43) Pub. Date: Aug. 12, 2004

(54) System and method for translating languages using an intermediate content space

(76) Inventor: Bjorn J. Gruenwald, Newtown, PA (US)

Correspondence Address: Rick A. Toering, Mintz Levin Cohn Ferris Glovsky and Popeo PC, Suite 900, 12010 Sunset Hills Road, Reston, VA, 20190, US

(21) Appl. No.: 10/770,391

(22) Filed: Feb. 4, 2004

Related U.S. Application Data
(60) Provisional application No. 60/444,618, filed on Feb. 4, 2003.

(51) Int. Cl. G06F 7/00

(52) U.S. Cl. 707/4

(57) ABSTRACT

A system and method for translating languages using an intermediate content space is provided. Content included in a language stream expressed in a first language is transformed into corresponding content expressed in a second language by transforming the content included in the language stream expressed in the first language into intermediate content in a content space, and transforming said intermediate content in the content space into the corresponding content expressed in the second language. In one embodiment, the content space is language agnostic.

### CROSS-REFERENCE TO RELATED APPLICATIONS

The present application claims priority to Provisional Application No. 60/444,618, entitled “System and Method for Translating Languages Using an Intermediate Contact Space,” which was filed on Feb. 4, 2003. The present application is also related to application Ser. No. 09/833,069, entitled “System and Method for Organizing Data,” which was filed on Apr. 12, 2001; which is related to U.S. Pat. No. 6,542,896 which issued on Apr. 1, 2003 from application Ser. No. 09/617,047, entitled “System and Method for Organizing Data,” which was filed on Jul. 14, 2000; which is related to U.S. Pat. No. 6,457,006 which issued on Sep. 24, 2002 from application Ser. No. 09/412,970, entitled “System and Method for Organizing Data,” which was filed on Oct. 6, 1999; which, in turn, is related to U.S. Pat. No. 6,424,969 which issued on Jul. 23, 2002 from application Ser. No. 09/357,301, entitled “System and Method for Organizing Data,” which was filed on Jul. 20, 1999. The contents of all of the above mentioned patents and patent applications are hereby incorporated by reference.

### BACKGROUND

1. Field of the Invention

The invention relates to managing content expressed in one or more languages and more particularly to a system and method for translating languages using an intermediate content space.

2. Discussion of the Related Art

Translating content expressed in a first language to that expressed in a second language is a difficult task. Conventional systems typically utilize an electronic dictionary specifically designed to translate terms in the first language to terms in the second language. Two separate electronic dictionaries are typically required for each pair of languages—one for translating from the first language to the second language and another for translating from the second language back to the first language.

Furthermore, many times these conventional systems fail to address the context of the term in the first language in selecting an appropriate term in the second language. This often results in nonsensical translations. Some attempts have been made to utilize synonyms via, for example, an electronic thesaurus, etc., in these conventional systems. Some attempts have also been made to provide one or more alternate terms in the second language for the term in the first language.

However, for other than very simple messages, these conventional systems are unable to accurately translate the content of the message expressed in the first language to the second language. Ultimately, human translators still are required.

What is needed is an improved system and method for translating languages.

### SUMMARY OF THE INVENTION

The invention provides a system and method for translating languages using an intermediate content space.

According to one embodiment of the invention, content included in a language stream expressed in a first language is transformed into a language agnostic content space by transforming the content in the language stream expressed in the first language into intermediate content in the content space. This embodiment allows the language stream to be manipulated without language dependent constructs.

According to another embodiment of the invention, content included in a language stream expressed in a first language is transformed into a language agnostic content space by transforming the content in the language stream expressed in the first language into intermediate content in the content space. This embodiment allows the content to be manipulated (e.g., stored, compared, simplified, optimized, etc.) in the content space without language dependent constructs. In some embodiments, the content may be translated back into the first language thereby improving or optimizing the expression of the language stream in the first language.

According to another embodiment of the invention, content included in a language stream expressed in a first language is transformed into corresponding content expressed in a second language by transforming the content in the language stream expressed in the first language into intermediate content in a content space, and then transforming the intermediate content into the corresponding content expressed in the second language.

According to another embodiment of the invention, an object in a first language space is translated to the object in a second language space by transforming the object in the first language space to the object in a language agnostic space, and then transforming the object in the language agnostic space to the object in the second language space.

These and other features and advantages of the invention will become apparent from the following drawings and description.

### BRIEF DESCRIPTION OF THE DRAWINGS

The invention is described with reference to the accompanying drawings. In the drawings, like reference numbers indicate identical or functionally similar elements. Additionally, the left-most digit(s) of a reference number identifies the drawing in which the reference number first appears.

FIG. 1 illustrates an exemplary environment in which the invention operates.

FIG. 2 is a system block diagram illustrating the operation of one embodiment of the invention.

FIG. 3 is a flow diagram illustrating the operation of one embodiment of the invention.

FIG. 4 is a flow diagram illustrating the operation of one embodiment of the invention.

### DETAILED DESCRIPTION

System Overview

The invention is directed to a system and method for translating languages using an intermediate content space. The invention is described below with respect to various exemplary embodiments, particularly with respect to various language translation applications. However, various features of the invention may be extended to other areas as would be apparent.

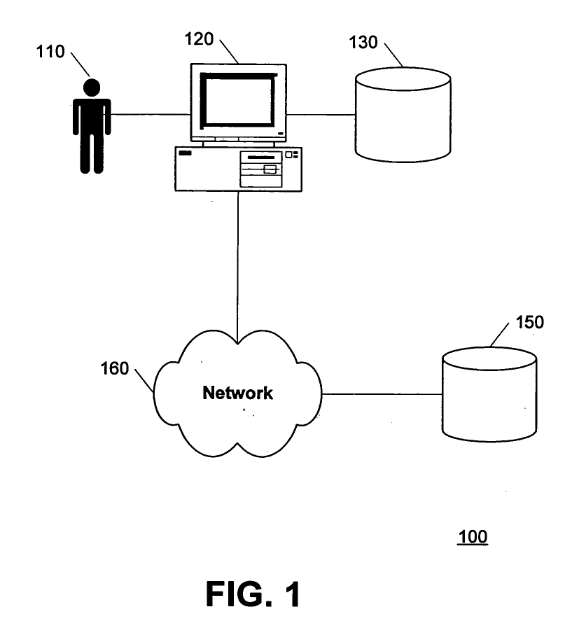

FIG. 1 illustrates an exemplary environment in which some embodiments of the invention operates. Environment 100 includes a user 110 interacting with a computer 120. In various embodiments, the invention is embodied in software, hardware, firmware or other similar structures and devices, and/or combinations thereof, operable on or with computer 120. Computer 120 may be connected through a network 160 to one or more data sources 150 that contain data. Network 160 may be an Internet, such as the World Wide Web (“the Web”), an intranet, such as a company LAN or similar network, or other networks including various wired or wireless connections. Computer 120 may also be connected to a local memory 130. Local memory 130 may or may not be resident within computer 120.

One aspect of some embodiments of the invention is to transform content of a language stream (e.g., message, passage, text, document, audio stream, etc.) expressed in a first language into a content space. In some embodiments of the invention, the content space is language agnostic. In other words, content in the content space is not constrained by language constructs, but rather comprises the thoughts, concepts, notions, ideas, etc., or other content structures that the first language, for better or for worse, attempts to convey. Once in the content space, the content can more readily and accurately be transformed into any second language, in most instances without loss of information, and independent of any language constructs of the first language.

Another aspect of some embodiments of the invention is that a one-to-one (or one-to-many) mapping of a term in a first language to a corresponding term(s) in a second language is not required as with conventional systems. Rather, one or more terms in the first language are transformed into their underlying content in the content space. Then the content in the content space can be transformed into one or more terms in the second language that most aptly and suitably express that content.

Another aspect of some embodiments of the invention is that the content space corresponds to a multi-dimensional space where content can be represented and/or manipulated in a mathematical fashion.

Another aspect of some embodiments of the invention is that a first language is represented as a multi-dimensional first language space with indices corresponding to each language construct (e.g., word, word root, hieroglyph, symbol, phoneme, etc.) within the first language. A language stream expressed in this first language space corresponds to an object in that space. Similarly, a second language is also represented as a multi-dimensional second language space with indices corresponding to each language construct within the second language. One or more coordinate transformations on the object in the first language space transform it into an object in a content space. The content space is also a multi-dimensional space with indices corresponding to various language agnostic content structures as opposed to the language dependent structures of the first and second multi-dimensional spaces. One or more coordinate transformations (or appropriate inverse coordinate transformations as would be apparent) on the object in the content space transform it into an object in the second language space. In some embodiments of the invention, the object in each of the various spaces is identical although it “appears” differently within each of the respective space.

Another aspect of some embodiments of the invention is that relationships (e.g., spatial, temporal, sequential, etc.) between one or more terms in the first language to one or more other terms in the first language are maintained so that content of the respective terms can be accurately transformed into the content space. In some embodiments, such relationships may be maintained, for example, using MMX files, as set forth in U.S. patent application Ser. No. 09/833,069, entitled “System and Method for Organizing Data,” which was filed on Apr. 12, 2001, which is incorporated herein by reference in its entirety.

Another aspect of some embodiments of the invention is that one or more terms in the first language may be converted into a numeric value prior to being transformed into the content space. In some embodiments, such a conversion may be accomplished, for example, as set forth in U.S. Pat. No. 6,424,969 to Gruenwald, entitled “System and Method for Organizing Data,” which issued on Jul. 23, 2002, which is incorporated herein by reference in its entirety. Multiple numeric values, each corresponding to a portion of a language stream may be combined as, for example, a vector for manipulation prior to and for the facilitating of the transformation of the terms into the content space.

Another aspect of some embodiments of the invention is that a language stream expressed in a first language may be formed into a vector corresponding to an list of terms (or their roots) used in the language stream. Each of the terms in the list may be converted into a numeric value thereby forming a numeric list vector corresponding to the terms in the language stream. Corresponding MMX files that maintain the relationships between the terms may be built as described above. Thus, this aspect of the invention converts a language stream expressed in the first language into a numeric list vector and an associated set of MMX files.

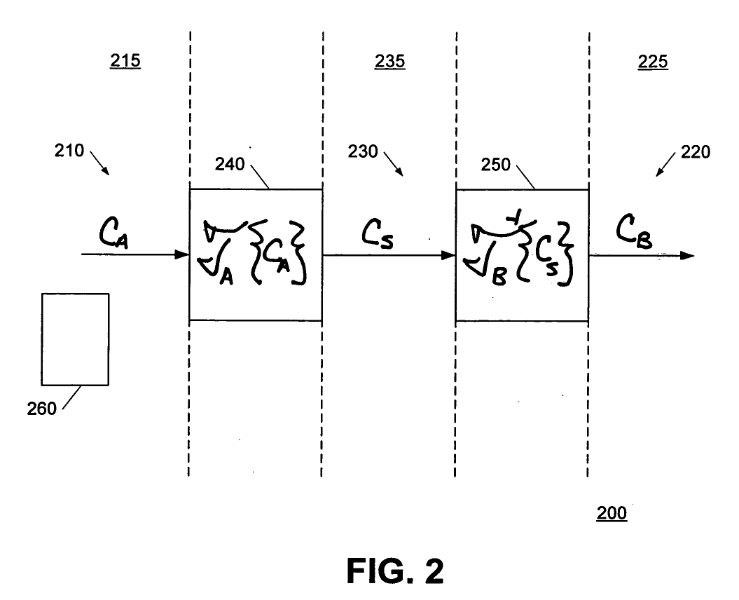

FIG. 2 is a system block diagram 200 that illustrates the various transformations according to one embodiment of the invention. A language stream 260 that includes content 210 (also denoted as C_{A} in FIG. 1) expressed in a first language 215 is received by a first transformation block or module (i.e., first transform 240). First transform 240 transforms content 210 from the first language 215 into content 230 (also denoted as C_{S} in FIG. 1) in a content space 235. Content 230 is received by a second transformation block or module (i.e., transform 250). Second transform 250 transforms content 230 in the content space 235 into content 220 (also denoted as C_{B} in FIG. 1) expressed in a second language 225. These transformations can be expressed mathematically as:

C_{S}= [symbol] _{A}{C_{A}}

C_{B}= [symbol] _{B}⁻¹{C_{S}}

where

C_{A} is content 210 expressed in the first language 215

C_{B} is content 220 expressed in the second language 225

C_{S} is content 230 expressed in content space 235

[symbol] _{A}{*} is a first transform for transforming content 210 from the first language 215 to the content space 235, and

[symbol] _{B}⁻¹{*} is an inverse of a second transform for transforming content 220 from the second language 225 to the content space 235.

In some embodiments of the invention, content 210, content 220, and content 230 are equivalent (or nearly so) although expressed in different frames of reference.

In some embodiments of the invention, the respective transforms 240, 250 correspond to linear transforms. In other embodiments of the invention, the respective transforms 240, 250 correspond to non-linear transforms on par with well known Fourier transforms, Laplace transforms, etc. In some embodiments of the invention, transforms 240, 250 correspond to coordinate transformations, linear or otherwise, from one language space to a language agnostic space and corresponding inverse coordinate transformations.

In some embodiments of the invention, transforms 240, 250 may comprise various non-linear operations whereby one or more dimensions in the respective language space are, for example, integrated temporally, spatially, sequentially, etc.

In some embodiments of the invention, various statistical processes may be used in order to, for example, interpolate content in a construct-poor language space ultimately to content in a construct-rich language space and vice-versa.

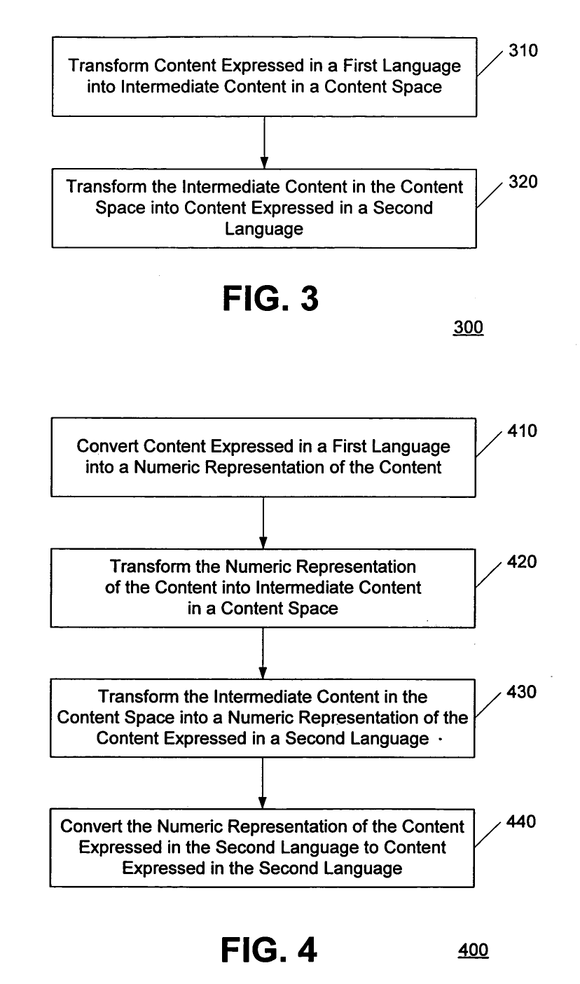

FIG. 3 illustrates an operation 300 according to one embodiment of the invention. In an operation 310, content 210 expressed in first language 215 is transformed into intermediate content 230 in content space 235. In an operation 320, intermediate content 230 in content space 235 is transformed into content 220 in second language 225.

FIG. 4 illustrates an operation 400 according to one embodiment of the invention. In an operation 410, content 210 expressed in a first language 215 is converted into a numeric representation of content 210 in the first language 215. In an operation 420, the numeric representation of the content 210 is transformed into intermediate content 230 in the content space 235. In an operation 430, the intermediate content 230 in the content space 235 is transformed into a numeric representation of the content 220 expressed in a second language 225. In an operation 440, the numeric representation of the content 220 expressed in the second language 225 is converted to the content 220 expressed in the second language 225.

While the invention has been described herein in terms of one or more embodiments, it is not so limited and is limited only by the scope of the following claims, as would be apparent to one skilled in the art.

What is claimed is:

1. A method for translating content included in a language stream expressed in a first language into corresponding content expressed in a second language comprising:
transforming the content included in the language stream expressed in the first language into intermediate content in a content space; and
transforming said intermediate content in the content space into the corresponding content expressed in the second language.

2. The method of claim 1, further comprising converting one or more terms in the language stream into a numeric value.

3. The method of claim 2, further comprising forming a numeric vector from a plurality of said numeric values, each of said plurality of numeric values corresponding to one or more terms in the language stream.

4. The method of claim 1, further comprising forming a list vector from the language stream expressed in the first language.

5. The method of claim 1, further comprising forming an numeric list vector from the language stream expressed in the first language.

6. The method of claim 3, further comprising building at least one MMX file associated with said numeric vector.

7. The method of claim 4, further comprising building at least one MMX file associated with said list vector.

8. The method of claim 5, further comprising building at least one MMX file associated with said numeric list vector.

9. A method for translating an object in a first language space to the object in a second language space comprising:
transforming the object in the first language space to the object in a language agnostic space; and
transforming the object in the language agnostic space to the object in the second language space.

10. A method for managing content comprising:
transforming an object in a first language space to the object in a language agnostic space; and
manipulating the object in the language agnostic space.

11. The method of claim 10, further comprising:
transforming the object in the language agnostic space to the object in the first language space.

12. The method of claim 10, further comprising:
transforming the object in the language agnostic space to the object in a second language space.
